(19) United States
(12) Patent Application Publication
(10) Pub. No.: US 2022/0164706 A1
(43) Pub. Date: May 26, 2022

(54) METHOD AND APPARATUS FOR PORTING ENTITY ON REINFORCEMENT LEARNING SYSTEM

(71) Applicant: ELECTRONICS AND TELECOMMUNICATIONS RESEARCH INSTITUTE, Daejeon (KR)

(72) Inventors: Seung Jae SHIN, Sejong-si (KR); Hong Seok JEON, Daejeon (KR)

(21) Appl. No.: 17/474,849

(22) Filed: Sep. 14, 2021

(30) Foreign Application Priority Data
Nov. 25, 2020 (KR) 10-2020-0160073

(51) Int. Cl. G06N 20/00

(52) U.S. Cl. CPC G06N 20/00

(57) ABSTRACT

The present invention relates to an apparatus and method for porting any hardware or software entity to a reinforcement learning system. The present invention includes receiving, by a proxy, a message including episode initiation information from an agent interface and delivering the message to an entity interface based on first synchronization; receiving, by the proxy, a message including first observation information from the entity interface and delivering the message to the agent interface based on second synchronization; receiving, by the proxy, a message including action information from the agent interface and delivering the message to the entity interface based on first synchronization; and receiving, by the proxy, a message including second observation information and reward information from the entity interface and delivering the message to the agent interface based on second synchronization.

### CROSS REFERENCE TO RELATED APPLICATION

The present application claims priority to Korean Patent Application No. 10-2020-0160073, filed on Nov. 25, 2020, the entire content of which is incorporated herein for all purposes by this reference.

### BACKGROUND OF THE INVENTION

### 1. Field of the Invention

The present invention relates to entity porting on a reinforcement learning system. Particularly, the present invention relates to a method and apparatus for porting an arbitrary hardware or software entity to a reinforcement learning system.

### 2. Description of Related Art

Reinforcement learning refers to a machine learning paradigm in which, based on observation of states in a certain environment, an agent is trained to repeat an action and be rewarded so that its decision-making capability is gradually improved.

### SUMMARY

An object of the present invention is to provide a common standard, library or framework comprehensively applicable to various application domains during reinforcement learning porting.

Another object of the present invention is to develop and reuse a common standard, library or framework comprehensively applicable to various application domains during reinforcement learning porting.

Another object of the present invention is to define a component and a procedure that are necessary for synchronization between an agent and an environment, when an arbitrary hardware or software entity is ported to a reinforcement learning system.

Other objects and advantages of the present invention will become apparent from the description below and will be clearly understood through embodiments. Also, it will be easily understood that the objects and advantages of the present invention may be realized by means of the appended claims and a combination thereof.

As a technical means to achieve the technical objects described above, the following steps may be included: receiving, by a proxy, a message including episode initiation information from an agent interface and delivering the message to an entity interface based on first synchronization; receiving, by the proxy, a message including first observation information from the entity interface and delivering the message to the agent interface based on second synchronization; receiving, by the proxy, a message including action information from the agent interface and delivering the message to the entity interface based on first synchronization; and receiving, by the proxy, a message including second observation information and reward information from the entity interface and delivering the message to the agent interface based on second synchronization.

As a technical means to achieve the technical objects described above, an agent interface, a proxy and an entity interface may be included. Herein, the proxy is configured to: receive a message including episode initiation information from the agent interface and deliver the message to the entity interface based on first synchronization; receive a message including first observation information from the entity interface and deliver the message to the agent interface based on second synchronization; receive a message including action information from the agent interface and deliver the message to the entity interface based on first synchronization; and receive a message including second observation information and reward information from the entity interface and deliver the message to the agent interface based on second synchronization.

As a technical means to achieve the technical objects described above, an agent interface, a proxy and an entity interface may be included. Herein, the agent interface may deliver a message including episode initiation information to the proxy, and the entity interface may receive the message including the episode initiation information from the proxy based on first synchronization. Herein, the entity interface may deliver a message including first observation information to the proxy, and the agent interface may receive the message including the first observation information from the proxy based on second synchronization. Herein, the agent interface may deliver a message including action information to the proxy, and the entity interface may receive the message including the action information from the proxy based on first synchronization. Herein, the entity interface may deliver a message including second observation information and reward information to the proxy, and the agent interface may receive the message including the second observation information and the reward information from the proxy based on second synchronization.

By providing a library or framework comprehensively applicable to various application domains, the present invention may reduce time and cost for a porting work to a reinforcement learning system.

By defining a component and a procedure necessary for synchronization between an agent and an environment in a comprehensive form applicable to various application domains, the present invention may enhance the flexibility, reusability and development efficiency of a research and development (R&D) process related to reinforcement learning.

### BRIEF DESCRIPTION OF THE DRAWINGS

FIG. 1 is a view showing the concept of reinforcement learning.

FIG. 2 is a view schematically showing the configuration of an entity porting apparatus in a reinforcement learning system applicable to the present disclosure.

FIG. 3 is a view showing an embodiment of an entity porting apparatus in a reinforcement learning system applicable to the present disclosure.

FIG. 4 is a view showing an operating procedure of each component when an initialization function is performed, which is applicable to the present disclosure.

FIG. 5 is a view showing an operating procedure of each component when an episode initiation function is performed, which is applicable to the present disclosure.

FIG. 6 is a view showing an operating procedure of each component when a decision-making function is performed, which is applicable to the present disclosure.

FIG. 7 is a view showing an operating procedure of each component when an observation and reward function is performed, which is applicable to the present disclosure.

FIG. 8 is a view showing an operating procedure of each component when a closing function is performed, which is applicable to the present disclosure.

FIG. 9 is a view showing a procedure of porting an arbitrary hardware or software entity to a reinforcement learning system, which is applicable to the present disclosure.

FIG. 10 is a view showing an example of apparatus configuration applicable to the present invention.

### DETAILED DESCRIPTION

Hereinafter, preferred embodiments according to the present invention will be described in detail with reference to the accompanying drawings. The detailed description set forth below in conjunction with the accompanying drawings is intended to describe exemplary embodiments of the present invention and is not intended to represent the only embodiments in which the present invention may be practiced. The following detailed description includes specific details in order to provide a thorough understanding of the present invention. However, one skilled in the art will be able to practice the invention without these specific details.

The following embodiments combine elements and features of the present invention in a predetermined form. Each component or feature may be considered optional unless explicitly stated otherwise. Each component or feature may be implemented in a form that is not combined with other components or features. In addition, some components and/or features may be combined to constitute an embodiment of the present invention. The order of operations described in embodiments of the present invention may be changed. Some features or features of one embodiment may be included in another embodiment, or may be replaced with corresponding features or features of another embodiment.

Specific terms used in the following description are provided to help the understanding of the present invention, and the use of these specific terms may be changed to other forms without departing from the technical spirit of the present invention.

In some cases, well-known structures and devices are omitted in order to avoid obscuring the concept of the present invention, or are shown in block diagram form focusing on core functions of each structure and device. In addition, the same reference numerals are used to describe the same components throughout this specification.

Also, in this specification, terms such as first and/or second may be used to describe various components, but the components should not be limited by the terms. The above terms are used only for the purpose of distinguishing one element from another element, for example, without departing from the scope of rights according to the concept of the present specification, a first element may be called a second element, and similarly, the second component may also be referred to as the first component.

In addition, throughout the specification, when a part “includes” a certain component, this means that other components may be further included, rather than excluding other components, unless otherwise stated. And the “ . . . unit”, “ . . . A term such as “unit” means a unit that processes at least one function or operation, which may be implemented as a combination of hardware and/or software.

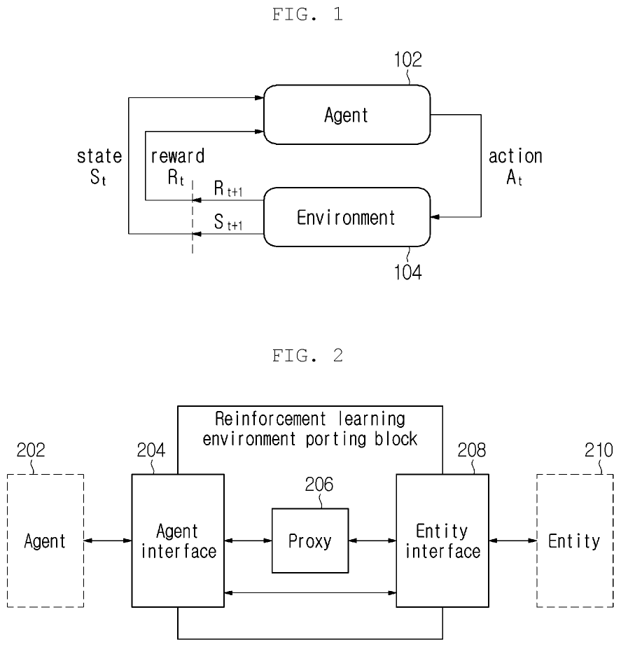

FIG. 1 is a view showing the concept of reinforcement learning. Reinforcement learning may be described as a form of interaction in which an agent 102 and an environment 104 repeat an observation-action-reward process. During the learning process, the agent 102 repeats the process of FIG. 1 and accumulates tuples. A tuple may have a form of a state Sₜ, an action Aₜ, a reward Rₜ, a next step state S₍ₜ₊₁₎ and a next step reward R₍ₜ₊₁₎. The accumulation of tuples by the agent 102 repeating the process of FIG. 1 refers to transition.

A unit of transitions gathered chronologically is called an episode. A set of multiple episodes is called an experience. A policy or a value function inside the agent 102 is evolved as the agent 102 obtains a higher accumulated reward sum through datafication of experiences. When a degree of evolution in the policy and value function satisfies a predefined criterion, learning is completed. In a next step of test and application, the agent having completed learning may operate only by performing the interaction of FIG. 1 with no evolving process of policy and value function.

Since its first introduction in the 1950s, reinforcement learning is recognized as one of the representative paradigms to solve various problems of control and optimization. Since 2010, reinforcement learning is combined with deep learning and is highlighted as a new break-through for innovating various systems requiring control and optimization. Currently, reinforcement learning demonstrates promising applicability in a variety of domains including game, robotics, unmanned aerial vehicle (UAV), autonomous driving, control of computing and communication network systems, management and finance.

According to a recent technical trend, porting hardware (HW) or software (SW) entities of various domains as environment entities of reinforcement learning processes seems to play a significant role in research and development (R&D) projects. As an example, in GitHub, a representative code sharing platform, development projects are observed to port applications of various domains as environment entities of reinforcement learning. Hereinafter, some examples of projects will be described.

The project ns3-gym ports ns3, which is simulation software widely used in the areas of communication and networking, to OpenAI Gym that is a reinforcement learning environment library. The project Carla-Ray-RLlib ports Carla, which is simulation software for autonomous driving, to RLlib, a reinforcement learning framework. The project GymFC ports a UAV controller to OpenAl Gym, which is a reinforcement learning environment library.

As described above, methodologies of porting external entities for a reinforcement learning system have up to now been significantly developed in each application domain. Nevertheless, further studies and innovations are still required for a universal-level porting methodology covering various domains and systems. Especially, in most cases of porting, synchronization is an indispensable function to be implemented by which an environment and a ported external entity stop operating during the control and decision-making of an agent, while the agent stops operating during the operation of the environment and the external entity. Hereinafter, a porting method and apparatus will be described which may cover various domains and systems.

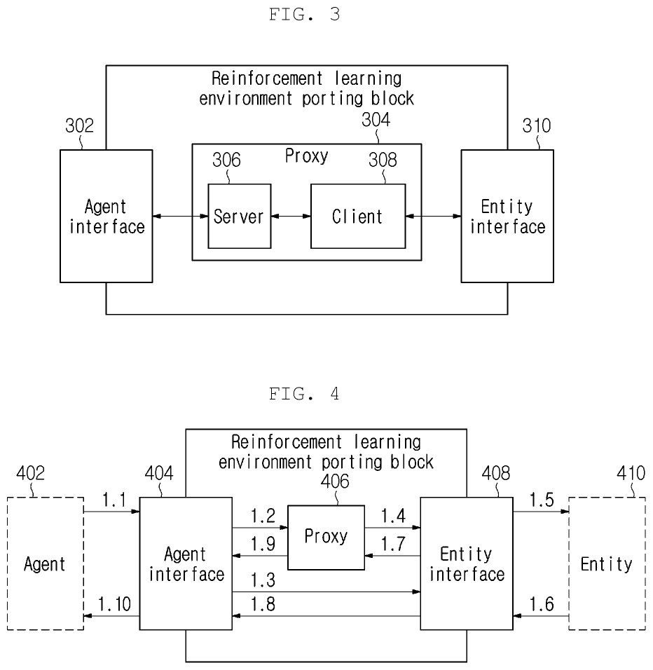

FIG. 2 is a view schematically showing the configuration of an entity porting apparatus in a reinforcement learning system applicable to the present disclosure. A reinforcement learning environment porting block includes an agent interface 204, a proxy 206 and an entity interface 208. Referring to FIG. 2, an agent 202 and an entity 210 are external components. The components shown in FIG. 2 are functional blocks and may be physically implemented in one or more circuits.

The agent 202 is an element in charge of control or decision-making for the entity 210. The agent 202 may be considered as hardware, software or an arbitrary system that is configured by combining hardware and software. The entity 210 may function as environment in the above-described concept of reinforcement learning of FIG. 1. The entity 210 may be considered as hardware, software or an arbitrary system that is configured by combining hardware and software. The reinforcement learning environment porting block may be located between the entity 210 and the agent 202. From the perspective of the entity 210, the reinforcement learning environment porting block may look like the agent 202. From the perspective of the agent 202, the reinforcement learning environment porting block may look like the entity 210.

Referring to FIG. 2, the bi-directional arrows indicate message exchange between each component. “Message” refers comprehensively to calls and responses of various signals, commands, data, functions and application programming interfaces (APIs), which are exchanged for interaction between the agent 210 and the entity 212.

The agent interface 204 may receive a message that the agent 202 delivers to an environment. The agent interface 204 may process the received message and deliver the received message to a proxy or the entity interface 208. In addition, the agent interface 204 may receive the message delivered from the proxy 206 or the entity interface 208. The agent interface 204 may process the received message and deliver the received message to the agent 202.

The proxy 206 may receive information delivered from the agent interface 204 and deliver a message, which is obtained by processing the information, to the entity interface 208. In addition, the proxy 206 may receive information delivered from the entity interface 208 and deliver a message, which is obtained by processing the information, to the agent interface 204. In addition, the proxy 206 may perform synchronization. That is, when the agent 202 makes a decision, the proxy 206 may stop, wait, suspend or sleep episode progress of the entity 210. On the other hand, the proxy 206 may perform synchronization that stops and suspends an operation of the agent 202 during the episode progress of the entity 210.

The entity interface 208 may receive information, which the entity 210 delivers to an environment, process the information when necessary, and deliver the processed information to the proxy 206 or the agent interface 204. In addition, the entity interface 208 may receive information, which the proxy 206 or the agent interface 204 delivers, process the information when necessary, and deliver the processed information to the entity 210.

Synchronization performed by the proxy 206 may be different according to details of implementation. According to an embodiment, in case the agent 202 and the entity 210 are implemented in different forms of thread or process, the proxy 206 may control an operation and waiting of the agent 202 and the entity 210 by using a synchronization mechanism for multi-thread or multi-process control. As examples of the above-described synchronization mechanism, there are a semaphore, a mutex, a condition and a lock.

According to another embodiment, in case the agent 202 and the entity 210 are implemented in different runtime environments that are separated at a long distance, the proxy 206 may be implemented as a client-server model, and synchronization may be implemented through blocking for suspending and waiting for a response of a counterpart. As an example of the above-described model, a transport control protocol (TCP)/Internet protocol (IP) socket may be used. Detailed implementation of the proxy includes the above-described examples but is not limited thereto.

FIG. 3 is a view showing an embodiment of an entity porting apparatus in a reinforcement learning system applicable to the present disclosure. A reinforcement learning environment porting block includes an agent interface 302, a proxy 304 and an entity interface 310. The proxy 304 includes a server 306 and a client 308. The components shown in FIG. 3 are functional blocks and may be physically implemented in one or more circuits.

In case an agent and a server are implemented in different runtime environments that are separate at a long distance, the proxy 304 may be embodied as a client-server model like in FIG. 3. As an example of client-server model, a TCP/IP socket may be used. In addition, synchronization may be realized through blocking for suspending and waiting for a response of a counterpart.

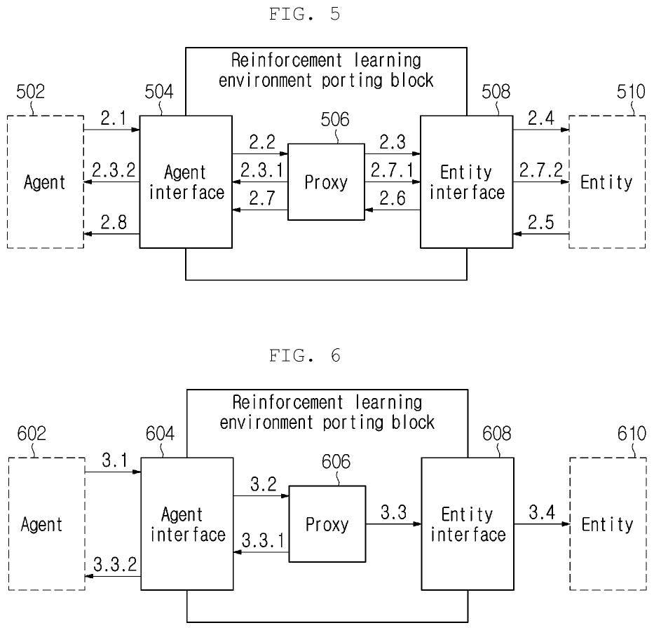

FIG. 4 is a view showing an operating procedure of each component when an initialization function is performed, which is applicable to the present disclosure. A reinforcement learning environment porting block includes an agent interface 404, a proxy 406 and an entity interface 408. Referring to FIG. 4, an agent 402 and an entity 410 are external components. The components shown in FIG. 4 are functional blocks and may be physically implemented in one or more circuits. Hereinafter, an initialization procedure will be described.

The agent 402 or an equivalent external system delivers the initialization message 1.1 to the agent interface 404. The message 1.1 may include various parameters necessary to initialize the agent interface 404, the proxy 406, the entity interface 408 and the entity 410.

The agent interface 404 receives the message 1.1 from the agent 402 or an equivalent external system. Based on the parameters included in the message 1.1, the agent interface 404 may initialize its internal operation parameters. Next, the agent interface 404 generates and delivers the message 1.2 or the message 1.3 to the proxy 406 and the entity interface 408. Depending on details of implementation, the message 1.2 or the message 1.3 may be delivered to either the proxy 406 or the entity interface 408 or to both of them.

The proxy 406 receives the message 1.2 from the agent interface 404. Based on parameters included in the message 1.2, the proxy 406 may initialize its internal operation parameters. The internal operation parameters may include parameters necessary for synchronization. Next, the proxy 406 generates and delivers the message 1.4 to the entity interface 408.

The entity interface 408 receives the message 1.3 from the agent interface 404 or the message 1.4 from the proxy 406. Based on parameters included in the message 1.3 or the message 1.4, the entity interface 408 may initialize its internal operation parameters. Depending on details of implementation, the entity interface 408 may be given either the message 1.3 or the message 1.4 or both of them. Next, the entity interface 408 generates and delivers the message 1.5 to the entity 410.

The entity 410 receives the message 1.5 from the entity interface 408. Based on parameters included in the message 1.5, the entity 410 may initialize its internal operation parameters. When entering a ready state in which initialization is completed, the entity 410 may generate and deliver the response message 1.6 to the entity interface 408. The message 1.6 may include various responses, signals or information to be notified to other components when initialization is completed.

The entity interface 408 receives the message 1.6 from the entity 410. When necessary, the entity interface 408 may update its internal operation parameters based on parameters included in the message. Next, the entity interface 408 generates and delivers the message 1.7 or the message 1.8 to the proxy 406 and the agent interface 404. Depending on details of implementation, the message 1.7 or the message 1.8 may be delivered to either the proxy 406 or the agent interface 404 or to both of them.

The proxy 406 receives the message 1.7 from the entity interface 408. When necessary, the proxy 406 may update its internal operation parameters based on parameters included in the message. Next, the proxy 406 generates and delivers the message 1.9 to the agent interface 404.

The agent interface 404 receives the message 1.8 from the entity interface 408 or the message 1.9 from the proxy 406. When necessary, the agent interface 404 may update its internal operation parameters based on parameters included in the messages. Depending on details of implementation, either the message 1.8 or the message 1.9 may be delivered or both of them may be delivered. Next, the agent interface 404 generates and delivers the message 1.10 to the agent 402 or an equivalent external system.

The agent 402 or an equivalent external system receives the message 1.10 from the agent interface 404. When necessary, the agent 402 or the equivalent external system may update its internal operation parameters based on parameters included in the message. Thus, initialization is completed.

In the operating procedure described above, a message generated by each component may include a parameter, which is delivered by a message that the each component receives in a previous step, or a new parameter that the each component generates by processing the parameter.

FIG. 5 is a view showing an operating procedure of each component when an episode initiation function is performed, which is applicable to the present disclosure. A reinforcement learning environment porting block includes an agent interface 504, a proxy 506 and an entity interface 508. Referring to FIG. 5, an agent 502 and an entity 510 are external components. The components shown in FIG. 5 are functional blocks and may be physically implemented in one or more circuits. Hereinafter, an episode initiation procedure will be described.

When performing episode initiation, the entity 510 should be in a ready state where initialization is completed or in a waiting state where decision-making is awaited during the progress of episode. According to an embodiment, an episode in progress may be closed, and a new episode may be initiated.

The agent 502 or an equivalent external system delivers the episode initiation message 2.1 to the agent interface 504. The message 2.1 may include various parameters necessary for episode initiation.

The agent interface 504 receives the message 2.1 from the agent 502 or an equivalent external system. When necessary, the agent interface 504 may update its internal operation parameter based on parameters included in the message. Next, the agent interface 504 generates and delivers the message 2.2 to the proxy 506.

The proxy 506 receives the message 2.2 from the agent interface 504. When necessary, the proxy 506 may update its internal operation parameters based on parameters included in the message. Next, the proxy 506 generates and delivers the message 2.3 to the entity interface 508. Herein, the message 2.3 aims to enable the entity 510 to initiate a new episode. In addition, the proxy 506 performs synchronization in which the agent 502 stops operation and turns into a waiting state. Herein, when necessary, the proxy 506 may order the agent 502 to stop and wait by delivering the message 2.3.1 to the agent interface 504. When necessary, the agent interface 504 may order the agent 502 to stop and wait by delivering the message 2.3.2 to the agent 502.

The entity interface 508 receives the message 2.3 from the proxy 506. Based on parameters included in the message 2.3, the entity interface 508 may update its internal operation parameters. Next, the entity interface 508 generates and delivers the message 2.4 to the entity 510.

The entity 510 receives the message 2.4 from the entity interface 508. Based on parameters included in the message 2.4, the entity 510 may initiate a new episode and start operation. According to an embodiment, the entity 510 may generate simulation and start operation based on parameters included in the message 2.4. Herein, in case the entity 510 is in a ready state where only initialization is completed and no episode is in progress, the entity 510 may initiate a new episode. On the other hand, in case the entity 510 is in a waiting state where decision-making is awaited during the progress of an episode, the entity 510 may end or cancel the episode and then initiate a new episode.

When control or decision-making of the agent 510 is necessary during the progress of an episode, the entity 510 delivers the decision-making request message 2.5 to the entity interface 508. The message 2.5 should include observation information that the entity 510 delivers to the agent 502.

The entity interface 508 receives the message 2.5 from the entity 510. When necessary, the entity interface 508 may update its internal operation parameters based on parameters included in the message. Next, the entity interface 508 generates and delivers the message 2.6 to the proxy 506.

The proxy 506 receives the message 2.6 from the entity interface 508. When necessary, the proxy 506 may update its internal operation parameters based on parameters included in the message. Next, the proxy 506 generates and delivers the message 2.7 to the agent interface 504. The message 2.7 aims to enable the agent 502 to perform decision-making according to a request of the entity 510. In addition, the proxy 506 performs synchronization in which the entity 510 stops the progress of an episode and turns into awaiting state. Herein, when necessary, the proxy 506 may order the entity 510 to stop and wait by delivering the message 2.7.1 to the entity interface 508. When necessary, the entity interface 508 may order the entity 510 to stop and wait by delivering the message 2.7.2 to the entity 510.

The agent interface 504 receives the message 2.7 from the proxy 506. When necessary, the agent interface 504 may update its internal operation parameters based on parameters included in the message. Next, the agent interface 504 generates and delivers the message 2.8 to the agent 502.

The agent 502 receives the message 2.8 from the agent interface 504. The agent 502 may resume operation and perform decision-making or reinforcement learning training.

In the operating procedure described above, a message generated by each component may include a parameter, which is delivered by a message that the each component receives in a previous step, or a new parameter that the each component generates by processing the parameter. According to an embodiment, the message 2.3 may include a parameter delivered by the message 2.2 or a new parameter that the proxy 506 generates by processing the parameter.

In the procedure described above, a detailed operation of synchronization, which the proxy 506 performs after delivering the message 2.3 or the message 2.7, may be different according to details of system implementation. According to an embodiment, in case the agent 502 and the entity 510 operate in a multi-thread form and the message 2.1 and the message 2.2 are implemented in a form of function call, when the proxy 506 blocks the message 2.2 through a synchronization mechanism, the agent 502 may turn into a waiting state for waiting for a response of a blocked function call and thus automatically stop operating. That is, it is not necessary to deliver explicitly the message 2.3.1 and the message 2.3.2. According to another embodiment, in case the agent 502 and the entity 510 operate in different runtime environments and the message 2.1 and the message 2.2 are implemented via packet communication, explicit delivery of the message 2.3.1 and the message 2.3.2 is needed.

In the operating procedure described above, the messages 2.1, 2.2, 2.3 and 2.4 are sequentially delivered thereby functioning as a signal initiating an episode, and the messages 2.5, 2.6 and 2.7 function as a response to episode initiation and a decision-making request signal from the entity 510 to the agent 502.

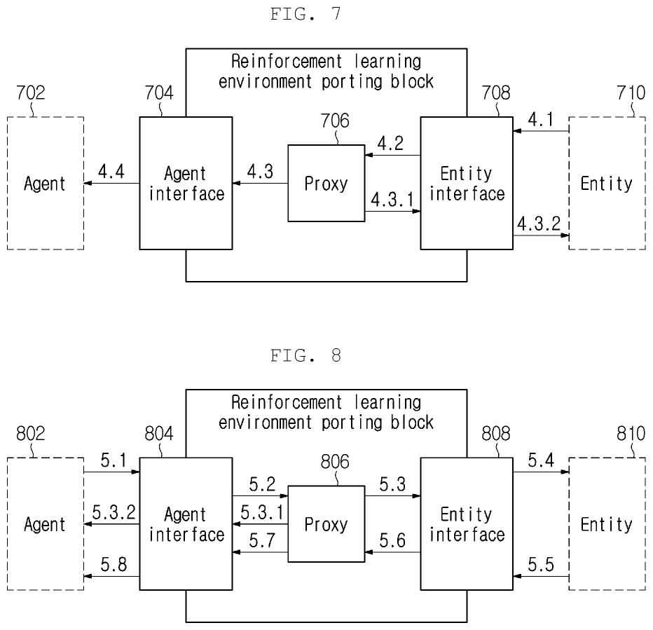

FIG. 6 is a view showing an operating procedure of each component when a decision-making function is performed, which is applicable to the present disclosure. A reinforcement learning environment porting block includes an agent interface 604, a proxy 606 and an entity interface 608. Referring to FIG. 6, an agent 602 and an entity 610 are external components. The components shown in FIG. 6 are functional blocks and may be physically implemented in one or more circuits. Hereinafter, a decision-making procedure will be described.

Decision-making is performed in a form of response to episode initiation or observe-and-reward procedure, and the entity 610 should be in a waiting state where the progress of an episode stops and decision-making is awaited.

The agent 602 or an equivalent external system delivers the decision-making message 3.1 to the agent interface 604. The message 3.1 includes a content of decision-making. Decision-making includes an action according to the concept of reinforcement learning. Specifically, applying this to the concept of FIG. 1, when a time unit is t, decision-making may mean Aₜ. When necessary, the decision-making message 3.1 may include additional parameters.

The agent interface 604 receives the message 3.1 from the agent 602 or an equivalent external system. The agent interface 604 may update its internal operation parameters based on parameters included in the message. Next, the agent interface 604 generates and delivers the message 3.2 to the proxy 606.

The proxy 606 receives the message 3.2 from the agent interface 604. When necessary, the proxy 606 may update its internal operation parameters based on parameters included in the message. Next, the proxy 606 generates and delivers the message 3.3 to the entity interface 608. The message 3.3 aims to enable the entity 610 to resume the progress of an episode according to decision-making of the agent 602. In addition, the proxy 606 performs synchronization in which the agent 602 stops operation and turns into a waiting state. Herein, when necessary, the proxy 606 may order the agent 602 to stop and wait by delivering the message 3.3.1 to the agent interface 604. When necessary, the agent interface 604 may receive the message 3.3.1 from the proxy 606. When necessary, the agent interface 604 may order the agent 602 to stop and wait by delivering the message 3.3.2 to the agent 602.

The entity interface 608 receives the message 3.3 from the proxy 606. When necessary, the entity interface 608 may update operation parameters necessary to deliver decision-making based on parameters included in the message. Next, the entity interface 608 generates and delivers the message 3.4 to the entity 610.

The entity 610 receives the message 3.4 from the entity interface 608. The entity 610 resumes operation and proceeds an episode according to decision-making including the message 3.4.

In the operating procedure described above, a message generated by each component may include a parameter, which is delivered by a message that the each component receives in a previous step, or a new parameter that the each component generates by processing the parameter. For example, the message 3.3 may include a parameter delivered by the message 3.2 or a new parameter that the proxy 606 generates by processing the parameter.

In the procedure described above, a detailed operation of synchronization performed by the proxy 606 after delivering the message 3.3 may be different according to detailed implementation of a system. An example of this is conceptually the same as an example of detailed synchronization operation described with reference to FIG. 6.

In the operating procedure described above, in a waiting state where the episode progress of the entity 610 is stopped, decision-making of the agent 602 is delivered through the messages 3.1, 3.2, 3.3 and 3.4. Thus, the operation of the entity 610 is resumed, and the agent 602 stops operation and turns into a waiting state.

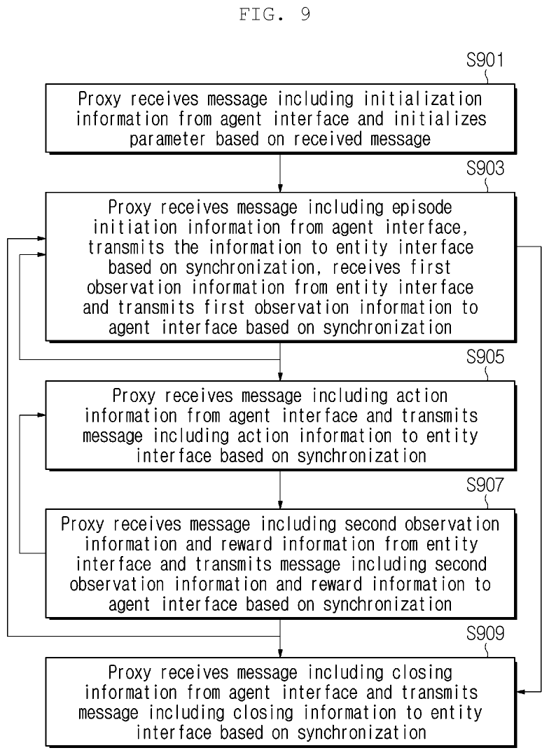

FIG. 7 is a view showing an operating procedure of each component when an observation and reward function is performed, which is applicable to the present disclosure. A reinforcement learning environment porting block includes an agent interface 704, a proxy 706 and an entity interface 708. Referring to FIG. 7, an agent 702 and an entity 710 are external components. The components shown in FIG. 7 are functional blocks and may be physically implemented in one or more circuits. Hereinafter, an observation and reward procedure will be described.

Observation and reward are performed in a form of responding to a decision-making procedure. The agent 702 should be in a waiting state where operation is stopped and observation and reward are awaited. The entity 710 delivers the observation and reward message 4.1 to the entity interface 708. The message 4.1 may include a reward for previous decision-making and a state observed in a current entity. Specifically, applying this to the concept of FIG. 1, when the current time is t, observation may indicate R(t−1) and reward may mean Sₜ respectively. In addition, a signal indicating whether or not an episode is closed may be included. In addition, when necessary, the message 4.1 may include additional parameters.

The entity interface 708 receives the message 4.1 from the entity 710. When necessary, the agent interface 708 may update an operation parameter necessary to deliver decision-making based on parameters included in the message. Next, the entity interface 708 generates and delivers the message 4.2 to the proxy 706.

The proxy 706 receives the message 4.2 from the entity interface 708. When necessary, the proxy 706 updates its internal operation parameters based on parameters included in the message. Next, the proxy 706 generates and delivers the message 4.3 to the agent interface 704. The message 4.3 aims to enable the agent 702 to resume decision-making and learning according to observation and reward delivered from the entity 710. In addition, the proxy 706 performs synchronization that stops the entity 710 from operating and turns the entity 710 into a waiting state. Herein, when necessary, the proxy 706 may order the entity 710 to stop and wait by delivering the message 4.3.1 to the entity interface 708. In addition, when necessary, the entity interface 708 may order the entity 710 to stop and wait by delivering the message 4.3.2 to the entity 710.

The agent interface 704 receives the message 4.3 from the proxy 706. When necessary, the agent interface 704 may update operation parameters necessary to deliver observation and reward based on parameters included in the message. Next, the agent interface 704 generates and delivers the message 4.4 to the agent 702.

The agent 702 receives the message 4.4 from the agent interface 704. The agent 702 may resume operation and perform decision-making or reinforcement learning training based on observation and reward included in the message 4.4.

In the operating procedure described above, a message generated by each component may include a parameter, which is delivered by a message that the each component receives in a previous step, or a new parameter that the each component generates by processing the parameter. According to an embodiment, the message 4.3 may include a parameter delivered by the message 4.2 or a new parameter that the proxy 706 generates by processing the parameter.

In the procedure described above, a detailed operation of synchronization performed by the proxy 706 after delivering the message 4.3 may be different according to detailed implementation of a system. An example of this is conceptually the same as an example of detailed synchronization operation described with reference to FIG. 6.

In the operating procedure described above, in a state where the agent 702 stops operation, the observation and reward of the entity 710 are delivered through the messages 4.1, 4.2, 4.3 and 4.4. Thus, the operation (decision-making) of the agent 702 is resumed, and the entity 710 stops operation and turns into a waiting state.

FIG. 8 is a view showing an operating procedure of each component when a closing function is performed, which is applicable to the present disclosure. A reinforcement learning environment porting block includes an agent interface 804, a proxy 806 and an entity interface 808. Referring to FIG. 8, an agent 802 and an entity 810 are external components. The components shown in FIG. 8 are functional blocks and may be physically implemented in one or more circuits. Hereinafter, a closing procedure will be described.

When closing an environment, the entity 810 should be in a ready state or in a waiting state where the progress of an episode is stopped. The agent 802 or an equivalent external system delivers the closing message 5.1 to the agent interface 804. The message 5.1 may include various parameters necessary to close the agent interface 804, the proxy 806, the entity interface 808 and the entity 810.

The agent interface 804 receives the message 5.1 from the agent 802. When necessary, the agent interface 804 may update its internal operation parameters necessary for closing based on parameters included in the message. Next, the agent interface 804 generates and delivers the message 5.2 to the proxy 806.

The proxy 806 receives the message 5.2 from the agent interface 804. Based on parameters included in the message 5.2, the proxy 806 may update its internal operation parameters necessary for closing. Next, the proxy 806 generates and delivers the message 5.3 to the entity interface 808. Herein, the message 5.3 aims to close an operation of the entity 810. The operation of the entity 810 may include an episode in progress. In addition, the proxy 806 performs synchronization in which the agent 802 stops operation and turns into a waiting state. According to an embodiment, when performing synchronization, the proxy 806 may deliver the message 5.3.1 to the agent interface 804, if necessary. When necessary, the agent interface 804 may receive the message 5.3.1 from the proxy 806. Accordingly, the agent interface 804 may order the agent 802 to stop and wait by delivering the message 5.3.2 to the agent 802.

The entity interface 808 receives the message 5.3 from the proxy 806. When necessary, the entity interface 808 may update internal parameters necessary for closing based on parameters included in the message. Next, the entity interface 808 generates and delivers the message 5.4 to the entity 810.

The entity 810 receives the message 5.4 from the entity interface 808. The entity 810 closes operation based on parameters included in the message 5.4. In a waiting state, operation may be immediately closed, but when an episode is going on, the operation may be closed after the episode is closed. In this process, information to be preserved may be saved or backed up. In addition, the entity 810 generates and delivers the response message 5.5 to the entity interface 808. The message 5.5 may include various responses, signals or information to be notified to other components when the entity 810 is closed.

The entity interface 808 receives the message 5.5 from the entity 810. When necessary, the entity interface 808 may update its internal operation parameters. Next, the entity interface 808 generates and delivers the message 5.6 to the proxy 806.

The proxy 806 receives the message 5.6 from the entity interface 808. When necessary, the proxy 806 may update its internal operation parameters. Next, the proxy 806 generates and delivers the message 5.7 to the agent interface 804. The message 5.7 aims to order the agent 802 to resume operate and then to close.

The agent interface 804 receives the message 5.7 from the proxy 806. When necessary, the agent interface 804 may update its internal operation parameters based on parameters included in the message. Next, the agent interface 804 generates and delivers the message 5.8 to the agent 802.

The agent 802 receives the message 5.8 from the agent interface 804. The agent 802 may resume operation and complete a closing procedure based on information included in the message 5.8.

In the operating procedure described above, a message generated by each component may include a parameter, which is delivered by a message that the each component receives in a previous step, or a new parameter that the each component generates by processing the parameter. According to an embodiment, the message 5.3 may include a parameter delivered by the message 5.2 or a new parameter that the proxy 806 generates by processing the parameter.

In the procedure described above, a detailed operation of synchronization performed by the proxy 806 after delivering the message 5.3 may be different according to detailed implementation of a system. An example of this is conceptually the same as an example of detailed synchronization operation described with reference to FIG. 6.

In the operating procedure described above, when the entity 810 is in a ready state or a waiting state, a closing signal is delivered through the messages 5.1, 5.2, 5.3 and 5.4. Thus, after the entity 810 is closed, the agent 802 is closed through the messages 5.5, 5.6, 5.7 and 5.8.

The three components (agent interface, proxy, entity interface) and five operating procedures (FIGS. 4 to 8), which are described above, may be illustrated in an actual reinforcement learning system porting procedure as follows.

When Icarus, which is network caching simulator software, is ported to OpenAI Gym that is a reinforcement learning environment library, Icarus functions as the entity of FIG. 2. A reinforcement learning environment porting block may be implemented in a form of child class inheriting a gym.Env class of OpenAI Gym. The gym.make( ) function of OpenAI Gym may be implemented by the initialization procedure of FIG. 4. The gym.Env.reset( ) method of OpenAI Gym may be implemented by the episode initiation procedure of FIG. 5. The gym.Env.step( ) method of OpenAI Gym may be implemented as a combination of decision-making procedure of FIG. 6 and the observation and reward procedure of FIG. 7. Herein, an additional function or method like get_decision( ) or get_action( ) may be defined which will function as the message 3.4 and 4.1 for Icarus. The gym.Env.close( ) method of OpenAI Gym may be implemented by the closing procedure of FIG. 8.

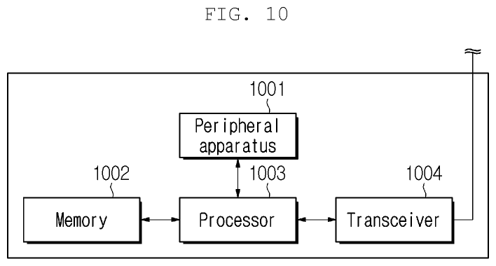

FIG. 9 is a view showing a procedure of reinforcement learning environment porting block that ports an arbitrary hardware or software entity to a reinforcement learning system, which is applicable to the present disclosure.

The step S901 is an initialization procedure. In the step S901, a proxy receives a message including initialization information from an agent interface and initializes a parameter based on the received message. Hereinafter, a detailed initialization procedure is the same as the procedure described in FIG. 4.

The step S903 is an episode initiation procedure. In the step S903, the proxy receives a message including episode initiation information from the agent interface, transmits the information to an entity interface based on synchronization, receives first observation information from the entity interface and transmits the first observation information to the agent interface based on synchronization. The step S903 may proceed after the step S901, the step S903 or the step S907 is done. That is, a new episode is initiated immediately after initialization, but it is possible to initiate a new episode after closing an existing episode. Hereinafter, a detailed episode initiation procedure is the same as the procedure described in FIG. 5.

The step S905 is a decision-making procedure. In the step S905, the proxy receives a message including action information from the agent interface and transmits a message including the action information to the entity interface based on synchronization. The step S905 may be proceeded after the step S903 or the step S907 is done. That is, decision-making is possible immediately after the agent receives first observation information as a result of episode initiation or immediately after the agent receives second observation information as a result of observation and reward. Hereinafter, a detailed decision-making procedure is the same as the procedure described in FIG. 6.

The step S907 is an observation and reward procedure. In the step S907, the proxy receives a message including second observation information and reward information from the entity interface and transmits a message including the second observation information and reward information to the agent interface based on synchronization. The step S907 may be proceeded after the step S905 is done. That is, the operation of the entity is possible immediately after the entity receives action information of the agent as a result of decision-making. Hereinafter, a detailed observation and reward procedure is the same as the procedure described in FIG. 7. The step S909 is a closing procedure. In the step S909, the proxy receives a message including closing information from the agent interface and transmits a message including the closing information to the entity interface based on synchronization. The step S909 may be proceeded after the step S903 or the step S907 is done. That is, it may execute when decision-making of the agent is possible. Hereinafter, a detailed closing procedure is the same as the procedure described in FIG. 8.

FIG. 10 is a view showing an example of apparatus configuration applicable to the present invention. Referring to FIG. 10, a device may include a memory 1002, a processor 1003, a transceiver 1004 and a peripheral apparatus 1001. In addition, as an example, the device may further include another configuration and is not limited to the above-described embodiment.

Herein, as an example, the device may be an apparatus that operates based on an entity porting method on the above-described reinforcement learning system. Specifically, the device of FIG. 10 may be an example of artificial intelligence (AI) apparatus for entity porting on a reinforcement learning system. The peripheral apparatus 1001 of FIG. 10 may obtain an image. The processor 1003 may perform calculation using the above-described equations. The memory 1002 may store the above-described matrix.

Herein, as an example, the memory 1002 may be a non-removable memory or a removable memory. In addition, as an example, the peripheral apparatus 1001 may include a display, GPS or other peripherals and is not limited to the above-described embodiment. In addition, as an example, like the transceiver 1004, the above-described device may include a communication circuit. Based on this, the device may perform communication with an external device.

In addition, as an example, the processor 1003 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device. Here, the processor 1003 may execute computer-executable commands stored in the memory 1002 in order to implement various necessary functions of node. As an example, the processor 1003 may control at least anyone operation among signal coding, data processing, power controlling, input and output processing, and communication operation. In addition, the processor 1003 may control a physical layer, an MAC layer and an application layer. In addition, as an example, the processor 1003 may execute an authentication and security procedure in an access layer and/or an application layer but is not limited to the above-described embodiment.

In addition, as an example, the processor 1003 may perform communication with other devices via the transceiver 1004. As an example, the processor 1003 may execute computer-executable commands so that a node may be controlled to perform communication with other nodes via a network. That is, communication performed in the present invention may be controlled. As an example, the transceiver 1004 may be used for communication among an agent interface, a proxy and an entity interface. As an example, other nodes may also be used for communication with an agent interface, a proxy, an entity interface and any other device. As an example, the transceiver 1004 may send a RF signal through an antenna and may send a signal based on various communication networks. In addition, as an example, MIMO technology and beam forming technology may be applied as antenna technology but are not limited to the above-described embodiment. In addition, a signal transmitted and received through the transceiver 1004 may be modulated and demodulated and thus be controlled by the processor 1003, which is not limited to the above-described embodiment.

Various embodiments of the present disclosure do not list all possible combinations but are intended to describe representative aspects of the present disclosure, and matters described in various embodiments may be applied independently or in combination of two or more.

In addition, various embodiments of the present disclosure may be implemented by hardware, firmware, software, or a combination thereof. For implementation by hardware, one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general purpose It may be implemented by a processor (general processor), a controller, a microcontroller, a microprocessor, and the like. For example, the processor may be implemented as software written in a computer-readable programming language, and may take various forms including the general-purpose processor. It is obvious that hardware may be disclosed in combination of one or more.

The scope of the present disclosure includes software or machine-executable instructions (eg, operating system, application, firmware, program, etc.) that cause an operation according to the method of various embodiments to be executed on a device or computer, and such software or and non-transitory computer-readable media in which instructions and the like are stored and executed on a device or computer.

The present invention described above can be various substitutions, modifications and changes within the scope without departing from the technical spirit of the present invention for those of ordinary skill in the art to which the present invention pertains, so the scope of the present invention is not limited to the above. It is not limited by one embodiment and the accompanying drawings. In addition, both product inventions and method inventions are described in this specification, and the descriptions of both inventions may be supplementally applied if necessary.

What is claimed is:

1. A method for porting an entity to a reinforcement learning system, the method comprising:
receiving, by a proxy, a message comprising episode initiation information from an agent interface and delivering the message to an entity interface based on first synchronization;
receiving, by the proxy, a message comprising first observation information from the entity interface and delivering the message to the agent interface based on second synchronization;
receiving, by the proxy, a message comprising action information from the agent interface and delivering the message to the entity interface based on first synchronization; and
receiving, by the proxy, a message comprising second observation information and reward information from the entity interface and delivering the message to the agent interface based on second synchronization.

2. The method of claim 1, wherein the first synchronization makes an agent stop operating and wait, when an episode of an entity is in progress.

3. The method of claim 2, wherein the delivering of the received message to the entity interface based on the first synchronization comprises delivering, by the proxy, a message comprising first synchronization information to the agent interface.

4. The method of claim 1, wherein the second synchronization stops and suspends episode progress of an entity, when an agent makes a decision.

5. The method of claim 4, wherein the delivering of the received message to the agent interface based on the second synchronization comprises delivering, by the proxy, a message comprising second synchronization information to the entity interface.

6. The method of claim 1, further comprising:
updating, by the proxy, if necessary, an internal operation parameter based on a received message, when receiving the message.

7. The method of claim 1, wherein the messages, which the proxy delivers to the entity interface or the agent interface, comprise a parameter, which is delivered from the messages received by the proxy, and a new parameter that the proxy generates based on the received messages.

8. The method of claim 1, further comprising:
receiving, by the proxy, initialization information from the agent interface;
initializing, by the proxy, a parameter based on a message comprising the initialization information, if necessary;
delivering, by the proxy, a message comprising the initialization information to the entity interface; and
receiving, by the proxy, a message comprising initialization response information from the entity interface and delivering the initialization response information to the agent interface.

9. The method of claim 1, further comprising:
receiving, by the proxy, a message comprising closing information from the agent interface and delivering the closing information to the entity interface based on first synchronization.

10. The method of claim 9, further comprising:
receiving, by the proxy, a message comprising closing response information from the entity interface and delivering the closing response information to the agent interface.

11. An apparatus for porting an entity to a reinforcement learning system, the apparatus comprising:
an agent interface;
a proxy; and
an entity interface,
wherein the proxy is configured to:
receive a message comprising episode initiation information from the agent interface and deliver the message to the entity interface based on first synchronization,
receive a message comprising first observation information from the entity interface and deliver the message to the agent interface based on second synchronization,
receive a message comprising action information from the agent interface and deliver the message to the entity interface based on first synchronization, and
receive a message comprising second observation information and reward information from the entity interface and deliver the message to the agent interface based on second synchronization.

12. The apparatus of claim 11, wherein the first synchronization makes an agent stop operating and wait, when an episode of an entity is in progress.

13. The apparatus of claim 12, wherein the delivering to the entity interface based on the first synchronization comprises delivering, by the proxy, a message comprising first synchronization information to the agent interface.

14. The apparatus of claim 11, wherein the second synchronization stops and suspends episode progress of an entity, when an agent makes a decision.

15. The apparatus of claim 14, wherein the delivering to the agent interface based on the second synchronization comprises delivering, by the proxy, a message comprising second synchronization information to the entity interface.

16. The apparatus of claim 11, wherein the proxy updates an internal operation parameter based on a received message, if necessary, when receiving the message.

17. The apparatus of claim 11, wherein the messages, which the proxy delivers to the entity interface or the agent interface, comprise a parameter, which is delivered from the messages received by the proxy, and a new parameter that the proxy generates based on the received messages.

18. The apparatus of claim 11, wherein the proxy receives initialization information from the agent interface,
wherein the proxy initializes a parameter based on a message comprising the initialization information, if necessary,
wherein the proxy delivers a message comprising the initialization information to the entity interface, and
wherein the proxy receives a message comprising initialization response information from the entity interface and delivers the initialization response information to the agent interface.

19. The apparatus of claim 11, wherein the proxy receives a message comprising closing information from the agent interface and delivers the closing information to the entity interface based on first synchronization, and
wherein the proxy receives a message comprising closing response information from the entity interface and delivers the closing response information to the agent interface.

20. An apparatus for porting an entity to a reinforcement learning system, the apparatus comprising:
an agent interface;
a proxy; and
an entity interface,
wherein the agent interface delivers a message comprising episode initiation information to the proxy, and the entity interface receives the message comprising the episode initiation information from the proxy based on first synchronization,
wherein the entity interface delivers a message comprising first observation information to the proxy, and the agent interface receives the message comprising the first observation information from the proxy based on second synchronization,
wherein the agent interface delivers a message comprising action information to the proxy, and the entity interface receives the message comprising the action information from the proxy based on first synchronization, and
wherein the entity interface delivers a message comprising second observation information and reward information to the proxy, and the agent interface receives the message comprising the second observation information and reward information from the proxy based on second synchronization.
